(19) United States
(12) Patent Application Publication
(10) Pub. No.: US 2025/0189245 A1
(43) Pub. Date: Jun. 12, 2025

(54) System and Method for Using a High-purity Hydrocarbon Heat-transfer Media

(71) Applicant: Richard Hiroshi Maruya, KANEOHE, HI (US)

(72) Inventor: Richard Hiroshi Maruya, KANEOHE, HI (US)

(21) Appl. No.: 19/056,461

(22) Filed: Feb. 18, 2025

Related U.S. Application Data
(63) Continuation-in-part of application No. 18/587,474, filed on Feb. 26, 2024, now abandoned.

(30) Foreign Application Priority Data
Apr. 18, 2023 (DE) 102023109698.2

(51) Int. Cl. F28F 23/00; C09K 5/10

(52) U.S. Cl. CPC F28F 23/00; C09K 5/10

(57) ABSTRACT

A system and method for using a high-purity hydrocarbon heat-transfer media includes a quantity of working fluid and a heat exchanger. The quantity of working fluid is a mixture of at least two high-purity hydrocarbons thus allowing the quantity of working fluid to function as an environmentally safe, non-toxic, and Perfluorinated and Polyfluorinated Acrylic Substances (PFAS) free high-purity hydrocarbon heat-transfer media. The heat exchanger is configured to transfer heat with the quantity of working fluid. The quantity of working fluid is configured to be safe for a surrounding environment as the quantity of working fluid leaks into the surrounding environment due to operational failure or operational degradation of the heat exchanger.

The current application is a continuation-in-part (CIP) application of the U.S. non-provisional application Ser. No. 18/587,474 filed on Sep. 17, 2024. The U.S. non-provisional application Ser. No. 18/587,474 claims a priority to the German patent application serial number 102023109698.2 filed on Apr. 18, 2023.

### FIELD OF THE INVENTION

The present invention relates to usage of high-purity hydrocarbon heat-transfer medias. More specifically, the present invention is a safe and non-toxic system that utilizes a high-purity hydrocarbon heat-transfer media within the heat exchanger.

### BACKGROUND OF THE INVENTION

A refrigerant is a working fluid used in the refrigeration cycle of air conditioning systems and heat pumps where in most cases they undergo a repeated phase transition from a liquid to a gas and back again. Refrigerants are heavily regulated due to their toxicity, flammability, and the contribution of Chlorofluorocarbons (CFC) and Hydrochlorofluorocarbons (HCFC) refrigerants to ozone depletion and that of Hydrofluorocarbon (HFC) refrigerants to climate change. Generally, refrigerants are used in a direct expansion system to transfer energy from one environment to another, typically, from inside a building to outside (or vice versa) commonly known as an “air conditioner” or “heat pump”. Refrigerants are found throughout the industrialized world, in homes, offices, and factories, in devices such as refrigerators, air conditioners, central air conditioning systems (HVAC), freezers, and dehumidifiers. When these units are serviced, there is a risk that refrigerant gas can vent into the atmosphere either accidentally or intentionally. Mistreatment of these refrigerant gases has been shown to deplete the ozone layer, increase air pollution, and is suspected to contribute to global warming.

Therefore, an objective of the present invention is to provide an environmentally safe, non-toxic, and Perfluorinated and Polyfluorinated Acrylic Substances (PFAS) free high-purity hydrocarbon heat-transfer media to use as the refrigerant. Due to the hydrogen and carbon mixture of the present invention, the high-purity hydrocarbon heat-transfer media can be safely released into the atmosphere. As a result, the present invention can be used as refrigerants in such items as: all types of refrigerators and similar systems for temperature control of compartments, all types of heating systems, all types of cooling systems, all types of ventilation systems, all types of air-conditioning systems, all types of heat pumps and heat pump-like systems, all types of mobile air-conditioning systems, regardless of the transport medium and the type of drive technology (e.g., all types of car, bus, ship, airplane, train air-conditioning systems), as well as all types of temperature control systems of transport refrigeration.

### BRIEF DESCRIPTION OF THE DRAWINGS

FIG. 1 is a schematic view showing the system of the quantity of working fluid and the heat exchanger of the present invention.

FIG. 2 is a schematic view showing the composition of the quantity of working fluid, wherein the quantity of working fluid is R-441A.

FIG. 3 is a schematic view showing the composition of the quantity of working fluid, wherein the quantity of working fluid is R-443A.

FIG. 4 is a flowchart illustrating an overall process for the method of the present invention.

### DETAILED DESCRIPTION OF THE INVENTION

All illustrations of the drawings are for the purpose of describing selected versions of the present invention and are not intended to limit the scope of the present invention.

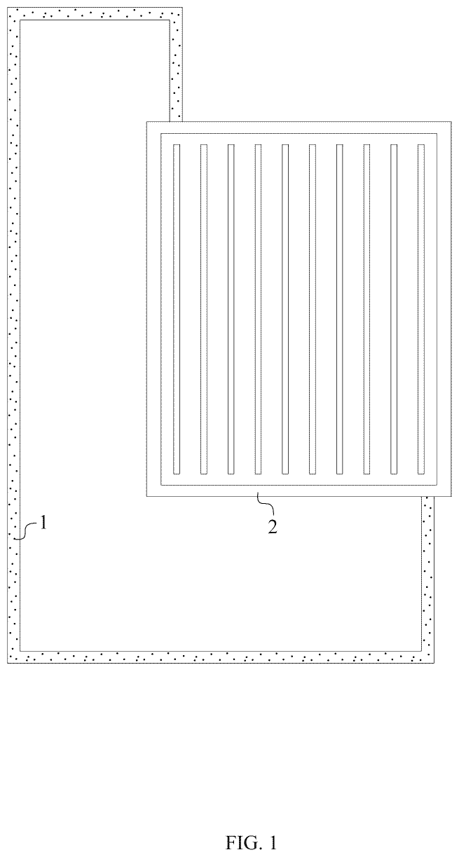

The present invention is a system for using a high-purity hydrocarbon heat-transfer media so that the high-purity hydrocarbon heat-transfer media can be inadvertently or intentionally released into atmosphere without any consequences. The high-purity hydrocarbon heat-transfer media functions as an environmentally safe, non-toxic, and Perfluorinated and Polyfluorinated Acrylic Substances (PFAS) free heat-transfer media so that the high-purity hydrocarbon heat-transfer media can be utilized in variety of heating systems, cooling systems, ventilating systems, and air conditioning systems. In reference to FIG. 1, the present invention comprises a quantity of working fluid 1 and a heat exchanger 2. The quantity of working fluid 1 is a mixture of at least two high-purity hydrocarbons and functions as the high-purity hydrocarbon heat-transfer media. The heat exchanger 2 is the mechanical apparatus that is configured to transfer heat with the quantity of working fluid 1. Moreover, the quantity of working fluid 1 is configured to be safe relative to a fluorinated-based working fluid for a surrounding environment regarding environmental and toxicity implications as the quantity of working fluid 1 is leaked into the surrounding environment due to operational failure or operational degradation of the heat exchanger 2.

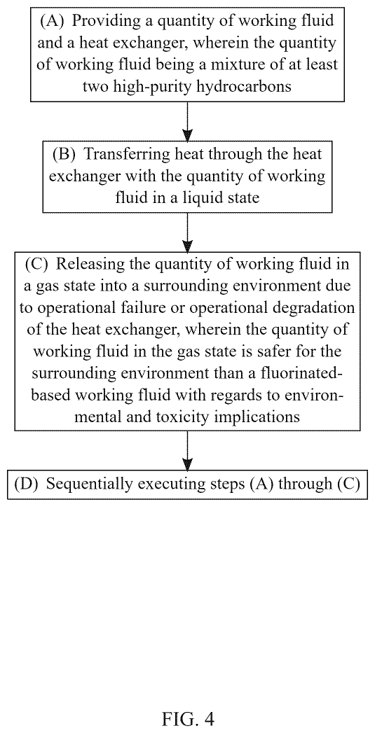

As can be seen in FIG. 4, the present invention follows an overall process in order to implement a method of using a high-purity hydrocarbon heat-transfer media. The overall process begins by providing a quantity of working fluid 1 and a heat exchanger 2 (Step A), wherein the quantity of working fluid 1 is a mixture of at least two high-purity hydrocarbons. The overall process continues by transferring heat through the heat exchanger 2 with the quantity of working fluid 1 in a liquid state (Step B). The overall process continues by releasing the quantity of working fluid 1 in a gas state into a surrounding environment due to operational failure or operational degradation of the heat exchanger 2 (Step C), wherein the quantity of working fluid 1 in the gas state is safer for the surrounding environment than a fluorinated-based working fluid with regards to environmental and toxicity implications. The overall process concludes by sequentially executing Step A through Step C (Step D).

The quantity of working fluid 1 is a refrigerant, a coolant, or a heat transfer medium as long as the quantity of working fluid 1 is able to function as a heat-transferring media. More specifically, the mixture of at least two high-purity hydrocarbons is low in moisture content. The mixture of at least two high-purity hydrocarbons can be any high-purity multi-mix hydrocarbon-based gas mixtures including, but not limited to, propane (R290), isobutane (R600a), N-butane (R600), ethane (R170), ethene (R1150), propene (R1270), and other high-purity hydrocarbons within the industry.

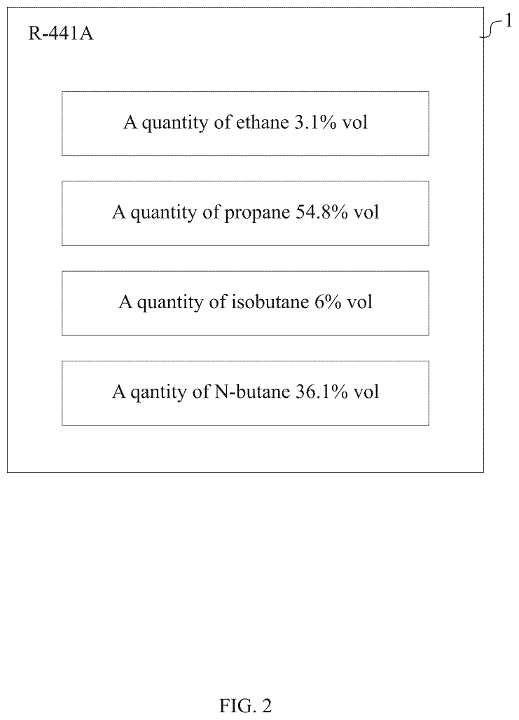

In some embodiments of the present invention, as shown in FIG. 2, the quantity of working fluid 1 is classified as R-441A refrigerant and may comprise a quantity of ethane, a quantity of propane, a quantity of isobutane, and a quantity of N-butane. In other to provide the optimal boiling point and faster flow rate within the heat exchanger 2, the quantity of ethane is approximately 3.1 percentage by volume (vol. %) of the quantity of working fluid 1 at normal temperature and pressure (NTP), the quantity of propane is approximately 54.8 vol. % of the quantity of working fluid 1 at NTP, the quantity of isobutane is approximately 6.0 vol. % of the quantity of working fluid 1 at NTP, and the quantity of N-butane is approximately 36.1 vol. % of the quantity of working fluid 1 at NTP. The faster flow rate and the optimal boiling point reduces the individual charge volume of the R-441A refrigerant thus reducing the workload of the heat exchanger 2 that directly results in energy savings. Preferably, the R-441A refrigerant is formulated for use in automotive air conditioning and other systems with a similar boiling point. In reference to the aforementioned compositional proportions in this paragraph, the term “approximately” preferably means within an error range of up to +0.5 vol. %.

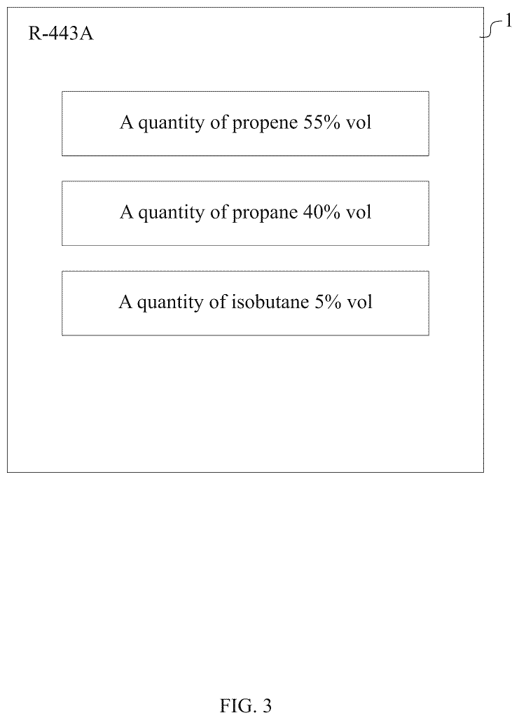

In some other embodiments of the present invention, as shown in FIG. 3, the quantity of working fluid 1 is classified as R-443A refrigerant and may comprise a quantity of propene, a quantity of propane, and a quantity of isobutane. In other to provide the optimal boiling point and faster flow rate within the heat exchanger 2, the quantity of propene is approximately 55.0 vol. % of the quantity of working fluid 1 at NTP, the quantity of propane is approximately 40.0 vol. % of the quantity of working fluid 1 at NTP, and the quantity of isobutane is approximately 5.0 vol. % of the quantity of working fluid 1 at NTP. The faster flow rate and the optimal boiling point reduces the individual charge volume of the R-443A refrigerant thus reducing the workload of the heat exchanger 2 that directly results in energy savings. Preferably, the R-443A refrigerant is formulated for use in heat pumps and other applications with a similar boiling point. In reference to the aforementioned compositional proportions in this paragraph, the term “approximately” preferably means within an error range of up to ±0.5 vol. %.

The quantity of working fluid 1 is completely free of PFAS or potential PFAS emitters and are equally non-toxic to humans and nature. According to OPEC (Organization of the Petroleum Exporting Countries), PFAS are defined as: Any substance containing at least one fully fluorinated methyl (CF3) or methylene (—CF2) carbon atom (with no H/CI/Br/I attached). PFAS are a group of industrial chemicals comprising a very large number of substances. PFAS are organic compounds in which the hydrogen atoms are completely (“perfluorinated”) or partially (“polyfluorinated”) replaced by fluorine atoms. Because of the water- and grease-repellent properties, as well as the stability and longevity (persistence), PFAS have been widely used for a long time in many industrial sectors as well as in the household. However, many PFAS are toxic, accumulate through the food chain. Once PFAS are released into the environment, are virtually impossible or very difficult to remove. Therefore, PFAS are also referred to as eternity chemicals.

PFAS have no natural source and have special physicochemical properties. As a result, PFAS are manufactured industrially and used in a variety of products; substances from the class of PFAS compounds are also used as refrigerants. Most of the older generation non-flammable refrigerants, such as dichlorodifluoromethane, R12, are either harmful to the ozone layer and/or have a high global warming potential (GWP) (such as 1,1,1,2-tetrafluoroethane, R134a). Most of the newer generation refrigerants (such as 2,3,3,3-tetrafluoropropene, R1234yf) have a lower GWP but have a significant PFAS input once they enter the environment. The 2,3,3,3-tetrafluoropropene, R1234yf have a lower GWP—but have a significant PFAS input as soon as released into the environment. In this context, the new generation refrigerants with lower GWP, such as R1234yf and other molecules of the hydrofluoroolefin-class (HFO's), decompose faster in the environment due to the presence of a chemically more unstable double bond—hence explaining their lower GWP. However, compounds such as the R1234yf, also favored by the high ultraviolet solar radiation in the higher layers of the atmosphere, likely react with molecules in the ambient air, especially oxygen radicals, and are converted to harmful PFAS compounds. The PFAS compounds are eventually washed into the soil with the rain, where PFAS compounds are not further degraded due to the chemical stability of the resulting compounds, and thus enter the food chain.

Due to their persistence and mobility, PFAS are detectable even in the most remote areas of the earth due to persistence and mobility characteristic of the PFAS. Under normal environmental conditions, no or very little abiotic or biotic degradation occurs. PFAS from contaminated soil also accumulate in agricultural products, such as leafy vegetables and fruits, and thus enter the food chain. PFAS are mainly ingested by humans through food. Consumption of contaminated drinking water also leads to elevated levels in humans in most cases. Volatile PFAS can also be absorbed by humans through the air. Due to the diversity of PFAS, current regulatory measures and options are insufficient to address the risks associated with this group of substances (“Zurich statement”). Despite the banning of several hundred compounds, exposure can continue for many years due to longevity of PFAS. At the same time, many of the PFAS currently in legal use have not yet been adequately characterized in terms of their potential environmental and health hazards, while longevity and distribution of PFAS in the environment is undisputed. The substance group of PFAS comprises more than 4000 individual substances as all PFAS remain in the environment for a long time. The regulation of this entire group of substances, compared to the step-by-step regulation of individual substances, should result in an efficient and rapid minimization of exposure to PFAS for humans and the environment. In addition, a switch to alternative PFAS, which are of similar concern, shall be prohibited.

The quantity of working fluid 1 functions as an environmentally friendly alternative to all known fluorinated refrigerant components, including the newly discovered substance class of hydrofluoroolefins (HFO's) as refrigerants, such as the 2,3,3,3-Tetrafluoropropen et al. The quantity of working fluid 1 is flammable and can be utilized as saturated media or unsaturated media. Resultantly, the quantity of working fluid 1 belongs to flammability class A3 (extremely flammable) and must be safety listed by an independent body, e.g., ASHRAE (the American Society of Heating, Refrigerating and Air-Conditioning Engineers), and each application-specific, individual mixture formula must be listed as “safety listed” or certified by a certified testing organization.

Since the quantity of working fluid 1 is non-toxic, the quantity of working fluid 1 has little to no environmental impact at best in the event of an accidental spill or release into the atmosphere, since hydrocarbons by their nature have no ozone depletion potential whatsoever and negligible global warming potential compared to fluorinated compounds. In other words, an unintentional release of the quantity of working fluid 1 into the environment does not produce any PFAS. The widespread use of the quantity of working fluid 1 as refrigerants or heat transfer media in suitable systems and applications would reduce the PFAS-induced environmental impact to null by substituting the fluorinated refrigerants currently in use with pure hydrocarbon blends. Furthermore, the pure multi blend hydrocarbon mixture can be used to compress, liquefy, or freeze solid propellant fuel. Thus, the quantity of working fluid 1 is configured to be chemically inert with the Earth's atmosphere. More specifically, the quantity of working fluid 1 may be configured to be chemically inert with ozone in the Earth's atmosphere.

The quantity of working fluid 1 is a low-viscosity refrigerant and provides improvement in the oscillating heat pump applications. The quantity of working fluid 1 allow to provide efficient cooling process for computer/server “farms” that currently use about 5% of all energy in the world, to run the internet and all the websites/social media platforms. The quantity of working fluid 1 can also be utilized for outer space travel.

The heat exchanger 2 can be utilized within a refrigerator system, a freezer system, a heating system, a cooling system, a ventilation system, an air conditioning system, and a heat pump system. Furthermore, the heat exchanger 2 can be utilized within all mobile systems (such as bus, train, ship, aircraft, or automobile air conditioning systems), regardless of propulsion technology, as well as the field of transport refrigeration. Furthermore, the heat exchanger 2 is utilized within heating, cooling, ventilation, and other air-conditioning systems and air-conditioning equipment, including heat pumps, and heat pump-like systems.

It is understood that HCR188C or HCR188C1 is the same refrigerant before the ASHRAE designation of R441A. HCR188C2 is the same refrigerant before the ASHRAE designation R443A.

The following references provide proof that a pure multi blend hydrocarbon refrigerant charge amount of 25% of the R441A vs 100% of the needed 134A refrigerant for a system. The R443a is around 35 to 45% of the R22 or R32A charge amount for a system.

### Drop-In Replacement of Refrigerant:

Remove old refrigerant from an existing system and do not alter or adjust any component of the system and replace it with either R441A or R443A multi blend pure hydrocarbon refrigerant. For example, a system that is running with 134A charge amount of 4 ounces requires R441A charge amount of 1 ounce to match the same level of performance, efficiency, and operation.

This is shown in reference to Intertek Job no. 3114280-414 and R-134a and HCR-188c conducted by Valco. In reference to testing R32A vs R443A, the Intertek no. 100437259COL-003FR shows the charge amount plus energy savings and reveals how each component of the pure hydrocarbon refrigerant is assessed by itself and as a blend and the benefits.

It is understood that a pure multi hydrocarbon blend refrigerant is a new to the refrigerant industry and none of industry experts have ever worked or used the pure multi hydrocarbon blend refrigerant to understand that the lower charge of the pure multi hydrocarbon blend refrigerant is needed operates a system that would translates into energy savings and maintaining performance.

R441A was developed as a drop in for the 134A systems. With being an A3 flammable in mind, the multi blend with different boiling points and pressure ratings were needed to lower the charge amount needed to operate in a closed system using 134A. Same was true for the R443A developed as a drop-in for R22 systems to insure the lower charge amount with the same performance. As a result, the R441A and R443A lower the risk factor in case of a leak with a possible ignition to create a fire. The decrease in the charge amount decreased the energy consumption required on the compressor of a system creating an energy savings. Furthermore, when a very slow leak to the atmosphere, R441A and R443A refrigerant do not create a problem with the environment and with a slow leak the amount of the pure hydrocarbon refrigerant mixed with the air is lower than the LOF Lower flammability limit.

In reference to Intertek's ETL certification mark, the present invention demonstrates the safety recognition known worldwide on all its certified products. In reference to the Intertek no. 100437259COL-003FR (project no. G100437259) conducted on Jul. 13, 2011 concludes when HCR-188C2 is substituted into an R-22 system as a drop in replacement for R-22, would require a refrigerant charge of only about 41% of the mass of R-22, and the compressor would use approximately 3% less energy than when used to operate with R-22 when viewed from an instantaneous power consumption standpoint. Cooling capacity cannot be determined, but of the four substances compared to R-22, HCR-188C2 appears to operate at the coldest temperature.

In reference to Intertek's ETL certification mark, the ETL mark is a product certification issued by Intertek: HCR-188C2 demonstrates a product's compliance to applicable standards such as ANSI, UL, CSA, ASTM, NFPA, and others that are most often safety-related.

In reference to EPA regulations under SNAP program in December 2011: the EPA is proposing to exempt from the venting prohibition hydrocarbons listed as “acceptable” or “acceptable under conditions” wherein:
Isobutane (R600a) and R441A, which were listed as acceptable, subject to use conditions, as refrigerant substitutes in household refrigerators, freezers, and combination of refrigerators and freezers.
Propane (R290), which was listed as acceptable, subject to use conditions, as a refrigerant substitute in stand-along retail food refrigerators and freezers.

In reference to Intertek Job no. 3114280-414 (Report no. 3114280CRT-003) on Apr. 9, 2007: the test results indicate that the factory charge R-134a charge in the system was tasted at 113 grams, then the appliance was evacuated and charged with the following charges: total HCR-188c charge in system for 25% its test was 28.3 grams. Then, the appliance was evacuated and charged with the following charges: total HCR-188c charge in system for 35% its test was 39.6 grams.

In reference to testing R-134a and HCR-188c conducted by Valco Engin cooling vehicle wind tunnel (on Jul. 9, 2007) wherein demonstrates the finding between the aforementioned two different refrigerants.

In reference to Testing R-32A vs. R443A conducted on Feb. 27, 2019 wherein demonstrates the finding between the aforementioned two different refrigerants.

One aspect of the present invention is that the high-purity hydrocarbon heat-transfer media can be used as an aerosol spray propellent. As an example, R441A is charged as a liquid and released to the atmosphere as it turns to vapor (i.e., means less is needed to propel whatever solution). R441A also blends with most cleaning agents (e.g., a brake cleaner used in the automotive industry) because a pure hydrocarbon blend is a cleaning agent that makes a great partnership with all aerosol cleaners. R441A also is nontoxic and safe for the environment and legal to be released to atmosphere including PFAS free as it is a perfect fit.

Another aspect of the present invention is that the high-purity hydrocarbon heat-transfer media has different boiling points to decrease its charge amount of use in a system. Lower charge amount reduces risk in case of a catastrophic leak in a system since Hydrocarbons are A3 flammable classified by ASHRAE. The high-purity hydrocarbon heat-transfer media uses less than a single hydrocarbon as a refrigerant. Less charge decreases energy consumption and decreases the size of a system. Hydrocarbons are non-toxic and can be released into the atmosphere, which will not bother the ozone or affect the GWP including the air quality. The high-purity hydrocarbon heat-transfer media makes a good fuel additive for propelling fuel it will not harm the atmosphere and burns very clean. Refrigerants are all ASHRAE classified, and safety listed with a safety organization (e.g., ETL Intertek). All refrigerants are classified for use conditions by the US EPA Stratosphere Ozone division and be listed on the use condition with the US Federal Register. This is not an easy process and requires a lot of time and funds to get the application completed for use in America.

Although the invention has been explained in relation to its preferred embodiment, it is to be understood that many other possible modifications and variations can be made without departing from the spirit and scope of the invention as hereinafter claimed.

What is claimed is:

1. A method for using a high-purity hydrocarbon heat-transfer media comprising:
(A) providing a quantity of working fluid and a heat exchanger, wherein the quantity of working fluid being a mixture of at least two high-purity hydrocarbons;
(B) transferring heat through the heat exchanger with the quantity of working fluid in a liquid state;
(C) releasing the quantity of working fluid in a gas state into a surrounding environment due to operational failure or operational degradation of the heat exchanger, wherein the quantity of working fluid in the gas state is safer for the surrounding environment than a fluorinated-based working fluid with regards to environmental and toxicity implications; and
(D) sequentially executing steps (A) through (C).

2. The method for using a high-purity hydrocarbon heat-transfer media as claimed in claim 1, wherein the quantity of working fluid is a refrigerant, a coolant, or a heat transfer medium.

3. The method for using a high-purity hydrocarbon heat-transfer media as claimed in claim 1, wherein the quantity of working fluid comprises a quantity of ethane, a quantity of propane, a quantity of isobutane, and a quantity of N-butane.

4. The method for using a high-purity hydrocarbon heat-transfer media as claimed in claim 3, wherein the quantity of ethane is approximately 3.1 percentage by volume (vol. %) of the quantity of working fluid at normal temperature and pressure (NTP), and wherein the quantity of propane is approximately 54.8 vol. % of the quantity of working fluid at NTP, and wherein the quantity of isobutane is approximately 6.0 vol. % of the quantity of working fluid at NTP, and wherein the quantity of N-butane is approximately 36.1 vol. % of the quantity of working fluid at NTP.

5. The method for using a high-purity hydrocarbon heat-transfer media as claimed in claim 1, wherein the quantity of working fluid comprises a quantity of propene, a quantity of propane, and a quantity of isobutane.

6. The method for using a high-purity hydrocarbon heat-transfer media as claimed in claim 5, wherein the quantity of propene is approximately 55.0 vol. % of the quantity of working fluid at NTP, and wherein the quantity of propane is approximately 40.0 vol. % of the quantity of working fluid at NTP, and wherein the quantity of isobutane is approximately 5.0 vol. % of the quantity of working fluid at NTP.

7. The method for using a high-purity hydrocarbon heat-transfer media as claimed in claim 1, wherein the quantity of working fluid is saturated or unsaturated.

8. The method for using a high-purity hydrocarbon heat-transfer media as claimed in claim 1, wherein the quantity of working fluid is flammable.

9. The method for using a high-purity hydrocarbon heat-transfer media as claimed in claim 1, wherein the quantity of working fluid is configured to be chemically inert with the Earth's atmosphere.

10. The method for using a high-purity hydrocarbon heat-transfer media as claimed in claim 9, wherein the quantity of working fluid is further configured to be chemically inert with ozone in the Earth's atmosphere.

11. The method for using a high-purity hydrocarbon heat-transfer media as claimed in claim 1, wherein the heat exchanger is selected from the group consisting of a refrigerator system, a freezer system, a heating system, a cooling system, a ventilation system, an air conditioning system, and a heat pump system.
